(19) United States
(12) Patent Application Publication
(10) Pub. No.: US 2006/0190737 A1
(43) Pub. Date: Aug. 24, 2006

(54) Portable information device

(75) Inventor: Mitsutoshi Miyasaka, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/328,776

(22) Filed: Jan. 10, 2006

(30) Foreign Application Priority Data
Feb. 22, 2005 (JP) 2005-045254

(51) Int. Cl. H04L 9/00

(52) U.S. Cl. 713/185; 713/186; 235/492

(57) ABSTRACT

A portable information device having a central processing unit and a power source coupled to the central processing unit and driving the central processing unit, comprises: an external control system circuit provided between the power source and the central processing unit, and providing power supply from the power source to the central processing unit by an external input; and an autonomous control system circuit providing power supply from the power source to the central processing unit under control of the central processing unit; the external control system circuit and the autonomous control system circuit being coupled in parallel with each other, the external control system circuit including a mechanical switch turned on and off by an external input, and the autonomous control system circuit including a transistor switch turned on and off under control of the central processing unit.

### BACKGROUND

1. Technical Field

The present invention relates to a portable information device, such as an integrated circuit (IC) card.

2. Related Art

Portable information devices having an identity authentication function to enhance security have been known in recent years. The function of identity authentication is achieved, for example, by providing a switch-driven fingerprint sensor on an IC card (portable information device) to take a user's fingerprint for authenticating the user. JP-A-2000-76412 is an example of related art.

Since this type of portable information device is powered by a battery or the like provided on the device, it has a limited power supply. It is, therefore, desirable to extend the time for driving this device by efficiently using its battery.

A technique has been developed to efficiently use power from the battery by providing a finger detection switch on the fingerprint sensor and making the device work only when a user places his or her finger on the sensor. JP-A-2002-207525 is an example of related art.

There has been developed another fingerprint detection device to reduce battery consumption by providing a lid to cover the sensor, so that the sensor can be driven by opening and dosing this lid. With the lid closed, for example, the sensor is in a power-saving state for the efficient use of the battery. JP-A-2004-21471 is an example of related art.

This kind of IC card (portable information device) is so small and thin that the capacity of the battery (power source) mountable on this card is limited.

However, the IC card according to the first example uses up its battery in a short time to the point that the fingerprint sensor is no longer able to work, since the sensor is always driven while the switch is on. Also, the device according to the second example keeps the sensor working while the device is driven even after the sensor authenticates a fingerprint. Accordingly, if this device is an IC card with a small battery capacity, it uses up its battery in a short time to the point that the sensor is no longer able to work.

As for the device according to the third example, it is structurally difficult to provide the lid on the IC card. The IC card with a small battery capacity would consume its battery even in a standby status.

### SUMMARY

An advantage of the invention is to provide a portable information device that is capable of being driven for longer time by efficiently using power from its power source.

A portable information device according to a first aspect of the invention having a central processing unit (CPU) and a power source coupled to the CPU and driving the CPU includes: an external control system circuit provided between the power source and the CPU, and providing power supply from the power source to the CPU by an external input; and an autonomous control system circuit providing power supply from the power source to the CPU under control of the CPU. The external control system circuit and the autonomous control system circuit are coupled in parallel with each other. The external control system circuit includes a mechanical switch turned on and off by an external input, while the autonomous control system circuit includes a transistor switch turned on and off under control of the CPU.

While the portable information device of the present aspect is not in use, both the mechanical switch and the transistor switch are off and do not supply power to the CPU. The portable information device of the present aspect may further include an electronic processing circuit that processes the device. The CPU controls power supply to this circuit. Therefore, no power is supplied to the CPU and the electronic processing circuit while the device is not in use, which saves power consumption. The mechanical switch is pressed to enable this device. The switch stays on and provides power supply to the CPU while this switch is pressed. Once the mechanical switch is turned on and starts providing power supply to the CPU, the CPU commands the autonomous control system circuit to turn on the transistor switch. The transistor switch included in the autonomous control system circuit stays on at least during the period the CPU commands so, and provides power supply to the CPU during this period. Accordingly, the CPU secures power supply to itself by keeping the transistor switch included in the autonomous control system circuit on, while the mechanical switch stays on. In other words, even if the mechanical switch is on to provides power supply to the CPU and turned off thereafter, the CPU controls on and off of the transistor switch on its own. Accordingly, the CPU does not lack power when the mechanical switch included in the external control system circuit is turned off, and controls power supply for itself with the autonomous control system circuit. After determining that the device completes predetermined processing and shutting off the power source, the CPU commands the autonomous control system circuit to turn off the transistor switch.

The portable information device of the present aspect may further include a capacitance provided between a positive power source and a negative power source of the autonomous control system circuit and in parallel with the CPU. The capacitance stores electric charge, while the power source supplies power to the CPU via the external control system circuit or the autonomous control system circuit. As the CPU commands the autonomous control system circuit to shut off power supply and then the transistor switch shifts to an off status, the electric charge stored in the capacitance is supplied to the CPU, securing the normal operation of the CPU. Even when power supply from the power source becomes less as the transistor switch is turned off, the CPU can complete the command to completely turn off the transistor switch with power supplied by the capacitance. The capacitance needs to store enough power for the CPU to keep commanding the autonomous control system circuit to shut off power supply even after the transistor switch is completely turned off. As the CPU uses up the electric charge stored in the capacitance, the CPU becomes a stop status with no power supplied. The CPU stays completely off until the mechanical switch is turned on to make the external control system circuit restart providing power supply. Accordingly, when the mechanical switch is not turned on and the device is not in use, the CPU receives no power, which saves power consumption due to standby power of the device, for example. It is thus possible to efficiently use the power source of the device. Furthermore, since the device stops power supply to the CPU on its own, it is possible to prevent unnecessary power consumption because a user forgets to turn off the power source of the device. Also, the mechanical switch included in the portable information device of the present aspect is preferably on while being pressed and off when being released. Accordingly, the mechanical switch is turned on simply by pressing it with a finger. After releasing the finger from the switch, power supply to the device is automatically shut off as mentioned above. Therefore, operability of the device is enhanced.

The portable information device of the present aspect may incorporate an electronic processing circuit that processes the device. As the CPU determines that the device completes predetermined processing, the CPU first shuts off power supply to the electronic processing circuit to stop the circuit, and then commands the autonomous control system circuit to turn off the transistor switch. The portable information device of the present aspect may further include an identity authentication function device. The CPU controls power supply to this device. The device takes identity authentication information by a command from the CPU. The operation of this device is determined by the CPU as necessary. The device receives power from the power source via the CPU only during its operation period. When the device shuts off its processing, the CPU commands the autonomous control system circuit to stop power supply to itself after stopping power supply to the identity authentication function device as well as to the electronic processing circuit. The CPU stops power supply to the electronic processing circuit and the identity authentication function device after they complete their roles, so that they can complete their functions safely, thereby minimizing the risk of damaging the device. As the identity authentication function device, a fingerprint sensor may be used, for example. The addition of this function can enhance security of the device.

### BRIEF DESCRIPTION OF THE DRAWINGS

The invention will be described with reference to the accompanying drawings, wherein like numbers reference like elements.

FIG. 1A schematically shows the internal structure of an IC card of a first embodiment, and FIG. 1B is its circuit diagram.

FIG. 2 is a flowchart for the IC card of the first embodiment.

FIG. 3A schematically shows the internal structure of an IC card of a second embodiment, and FIG. 3B is its circuit diagram.

FIG. 4 is a flowchart for the IC card of the second embodiment.

FIG. 5A schematically shows the internal structure of an IC card of a third embodiment, and FIG. 5B is its circuit diagram.

FIG. 6 is a flowchart for the IC card of the third embodiment.

FIG. 7A schematically shows the internal structure of an IC card of a fourth embodiment, and FIG. 7B is its circuit diagram.

FIG. 8 is a flowchart for the IC card of the fourth embodiment.

### DESCRIPTION OF EXEMPLARY EMBODIMENTS

Embodiments of the invention will be described with reference to the accompanying drawings. The scale of elements is adequately changed in the drawings, so that they are easily visible.

The embodiments show examples in which the invention is applied to IC cards (portable information devices), while examples of portable information devices may also include mobile phones and personal digital assistants.

### First Embodiment

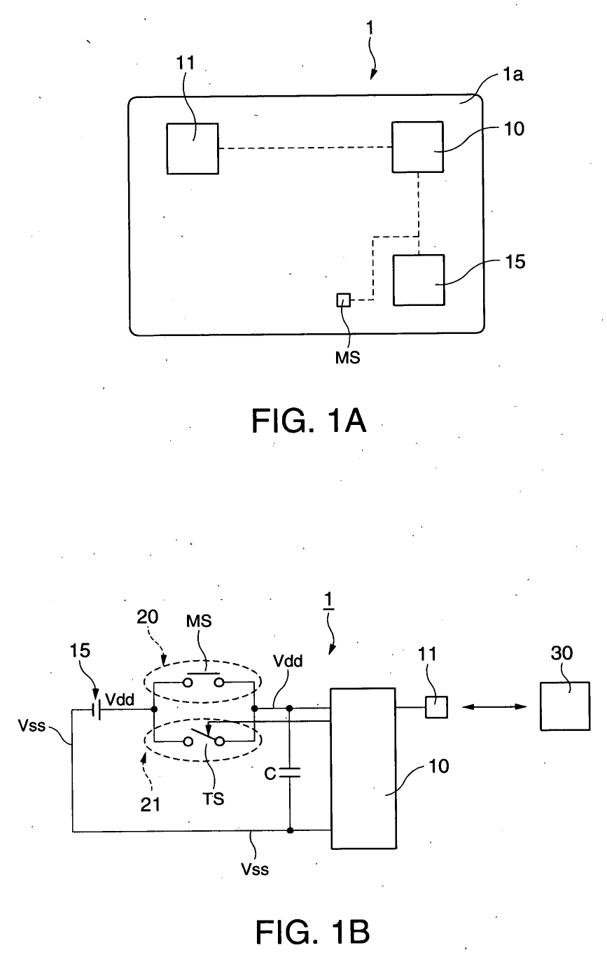

FIG. 1A is a plan view schematically showing the internal structure of an IC card (portable information device) according to a first embodiment of the invention. Referring to the view, this IC card 1 of the present embodiment includes a card substrate 1a, a central processing unit (CPU) 10 for arithmetic operations, a power source 15 coupled to the CPU 10 and serving as a battery to drive the CPU 10, an IC unit 11 controlled by the CPU 10, and a button-shaped micro (μ) switch (mechanical switch) MS that is turned on and off by external inputs. As the micro switch MS, a mechanical switch that is turned on when pressed and turned off when released is used here.

FIG. 1B is a schematic circuit diagram of the IC card 1 of the present embodiment.

Referring to the diagram, provided between the power source 15 and the CPU 10 are an external control system circuit 20 that provides power supply from the power source 15 to the CPU 10 while the micro switch MS is pressed, and an autonomous control system circuit 21 that provides power supply from the power source 15 to the CPU 10 under the control of the CPU 10. The circuits 20 and 21 are connected in parallel.

The external control system circuit 20 is provided with the micro switch MS. Pressing the switch MS turns on the external control system circuit 20, and releasing the switch MS turns off the external control system circuit 20.

The autonomous control system circuit 21 is provided with a transistor switch TS that is turned on and off by the CPU 10.

Provided between the positive power source of the power source 15 coupled with the autonomous control system circuit 21 and the negative power source of the power source 15 is a capacitance C composed of a capacitor, for example, and connected in parallel with the CPU 10. While the power source 15 supplies power to the CPU 10, electric charge is stored in the capacitance C. The CPU 10 is also coupled with the IC unit 11. The IC unit 11 includes a control part controlled by the CPU 10, a ROM for storing data, a DRAM for temporarily storing input/output data and arithmetic data and passing them to the output side, and an arithmetic part.

The IC unit 11 inputs and outputs data to and from an external device 30, which is separated from the IC card 1 as described below in greater detail. Examples of this external device 30 may include a bank's automatic teller machine and a credit card reader device.

With this structure, the CPU 10 starts running with power from the power source 15 and controls the IC unit 11, enabling the IC card 1 to be used.

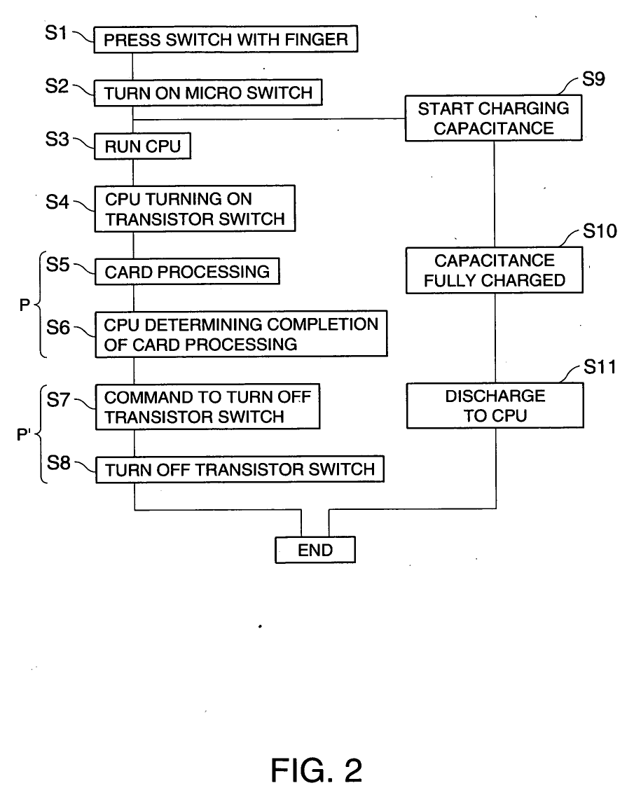

Referring now to the flowchart of FIG. 2, the use of the IC card 1 will be explained.

While the IC card 1 is not in use, it is assumed that both the micro switch MS and the transistor switch TS are off. This means that no power is supplied from the power source 15 to the CPU 10, and therefore no power from the power source 15 is consumed.

First, a user presses the micro switch MS included in the IC card 1 with his or her finger to turn on this switch MS (Steps S1 and S2).

As a result, the power source 15 starts supplying power to the CPU 10 via the external control system circuit 20. Consequently, the capacitance C connected in parallel with the CPU 10 starts to store electric charge (Step S9).

As the power source 15 supplies power to the CPU 10, the CPU 10 starts running as mentioned above (Step S3).

The CPU 10 then issues a command to turn on the transistor switch TS included in the autonomous control system circuit 21 (Step S4).

The power source 15 then supplies power to the CPU 10 via the autonomous control system circuit 21. Here, the CPU 10 receives power from the power source 15 both via the external control system circuit 20 and the autonomous control system circuit 21.

Releasing the finger from the micro switch MS turns off this switch as mentioned above. As a result, the external control system circuit 20 stops providing power supply from the power source 15 to the CPU 10. As the micro switch MS is turned off, the CPU 10 starts controlling on and off of the transistor switch TS on its own.

In other words, the CPU 10 keeps the transistor switch TS on until data processing between the IC card 1 and the external device 30 shown in FIG. 1B is completed. Accordingly, the CPU 10 continues to receive power from the power source 15 via the autonomous control system circuit 21.

Storing electric charge in the capacitance C, which started in Step S9, continues via the autonomous control system circuit 21 with the transistor switch TS staying on, even after the micro switch MS is turned off and stops power supply via the external control system circuit 20 as mentioned above. After a while the capacitance C is fully charged (Step S10). It is assumed that, even after the transistor switch TS is completely turned off, the capacitance C stores enough power for the CPU 10 to keep commanding the autonomous control system circuit 21 to shut off power supply.

After Step S4, that is, after the transistor switch TS is turned on, the IC card 1 communicates data with the external device 30. The example described here uses a credit card reader terminal as the external device 30. Specifically, the CPU 10 communicates data, e.g. a password, stored in the IC unit 11 shown in FIG. 1B with the external device (credit card reader terminal) 30 to compare the data with data held in the external device 30 (Step S5).

When the data in the IC card 1 match the data in the external device 30 and the data communications are carried out successfully, predetermined processing with the external device 30 is completed.

As the data communications with the external device 30 finish, the CPU 10 determines that the predetermined processing is completed (Step S6).

The CPU 10 then issues a command to turn off the transistor switch TS (Step S7).

After issuing the command to turn off the transistor switch TS, the CPU 10 keeps commanding this until the switch TS is turned off. After a while the transistor switch TS is turned off (Step S8).

When the transistor switch TS is turned off, the CPU 10 forms a closed circuit with the capacitance C that has been fully charged. Accordingly, discharging the capacitance C to the CPU 10 can drive the CPU 10 (Step S11).

The CPU 10 becomes a stop status by commanding itself to stop so as to stop power supply from the capacitance C.

While the IC card 1 of the present embodiment is not in use, the power supply 15 does not supply power to the CPU 10. Since the CPU 10 does not start running in a standby status, it is possible to reduce consumption of the power source 15 due to standby power of the IC card 1, for example. Thus the power source 15 of the IC card 1 can be efficiently used.

Moreover, since pressing the micro switch MS makes the CPU 10 run and releasing the switch MS makes the IC card 1 stop power supply to the CPU 10 on its own, it is possible to prevent unnecessary consumption of the power source 15 because the user forgets to turn off the switch of the IC card 1, for example.

Note that releasing the micro switch MS can be anytime after the CPU 10 turns on the transistor switch TS, and can be while the IC card 1 communicates and processes data with the external device 30 since the transistor switch TS provides power supply to the CPU 10.

### Second Embodiment

An IC card according to a second embodiment of the invention will now be described. The IC card of the present embodiment is provided by adding an electronic processing circuit to which power is supplied from the power source 15 under the control of the CPU to the IC card 1 of the first embodiment. Here, like numerals indicate like elements of the IC card 1, and like processes are omitted in a flowchart, which will be described later, and explanation thereof is simplified.

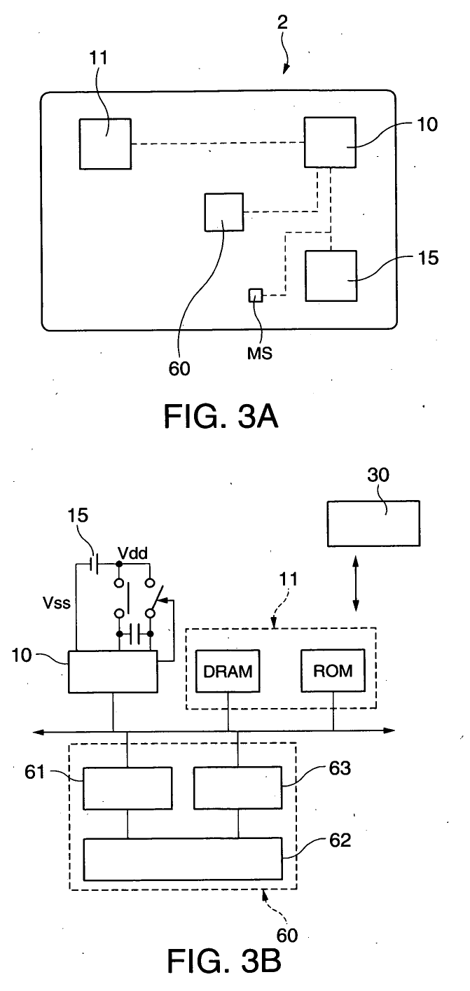

FIG. 3A is a plan view schematically showing the internal structure of the IC card of the present embodiment. Referring to the view, this IC card 2 includes an encryption unit 60 composed of an electronic processing circuit, which will be described in greater detail later, in addition to the elements of the IC card 1: the CPU 10, the power source 15, the IC unit 11 and the micro switch MS. This encryption unit 60 processes the IC card 2 as mentioned below.

FIG. 3B is a block diagram showing the IC card 2 of the second embodiment.

Referring to this diagram, the IC card 2 includes the encryption unit 60 composed of an electronic processing circuit in addition to the IC card 1.

This encryption unit 60 includes an encryption device 61 having an encoder, a nonvolatile memory 62 having a ROM or the like, and a decryption device 63 having a decoder. The decryption device 63 decrypts encrypted data input from the external device 30 and the encryption device 61 encrypts data to be output from the IC card 2, enabling data communications between the card and the device and enhancing security for using the card 2.

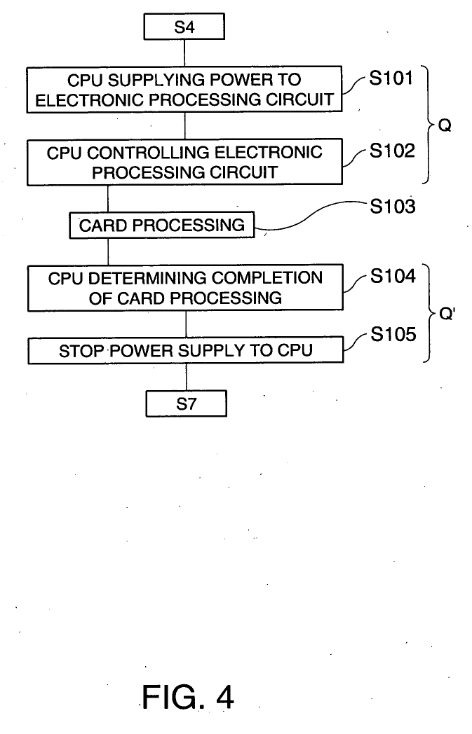

Referring now to the flowchart of FIG. 4, the use of the IC card 2 will be explained. The flowchart of the present embodiment includes processing by the encryption unit (electronic processing circuit) 60 replacing Process P, i.e. Steps S5 and S6, of the first embodiment shown in FIG. 2.

FIG. 4 shows processing by the encryption unit 60, i.e. Steps S101 to S105, and explanation of the same processes as in the first embodiment is simplified.

First, a user presses the micro switch MS included in the IC card 2 with his or her finger to turn on this switch MS and supply power to the CPU 10 (Steps S1 and S2) in the same manner as in the first embodiment. Consequently, the capacitance C starts to store electric charge (Step S9).

Making the CPU 10 start running turns on the transistor switch TS included in the autonomous control system circuit 21 (Steps S3 and S4). Subsequently, releasing the finger from the micro switch MS turns off this switch.

After the transistor switch TS is turned on (Step S4), referring to the flowchart of FIG. 4, the CPU 10 provides power supply from the power source 15 to the encryption unit 60 (Step S101). The encryption unit 60 thus becomes a communicable status with the external device 30 under the control of the CPU 10 (Step S102).

Then in the same manner as in the first embodiment, the IC card 2 communicates data with a credit card reader terminal (external device 30). Since the IC card 2 of the present embodiment includes the encryption unit 60, the IC card 2 communicates data encrypted by the encryption unit 60 with the reader terminal. Normally completing data communications between the IC card 2 and the reader terminal means the completion of payment with the credit card (Step S103).

As the payment with the credit card finishes, the CPU 10 determines that predetermined processing is completed (Step S104).

The CPU 10 then issues a command to stop power supply from the power source 15 to the encryption unit 60 (Step S105).

The CPU 10 confirms that a display unit 50 is turned off and then goes on to the Steps S7 and S8, described in the first embodiment. Specifically, the CPU 10 issues a command to turn off the transistor switch TS (Step S7). After issuing the command to turn off the transistor switch TS, the CPU 10 keeps commanding this until this switch TS is turned off. After a while the transistor switch TS is turned off (Step S8).

When the transistor switch TS is turned off, the CPU 10 forms a circuit with the capacitance C that has been fully charged. Accordingly, discharging the capacitance C to the CPU 10 can drive the CPU 10 (Step S11).

The CPU 10 becomes a stop status by stopping power supply from the capacitance C.

While the IC card 2 of the present embodiment is not in use, the power supply 15 does not supply power to the CPU 10. Since the CPU 10 does not start running in a standby status, it is possible to reduce consumption of the power source 15 due to standby power of the IC card 2, for example. Accordingly, an increase in power consumed by the addition of the encryption unit (electronic processing circuit) 60 can be kept to minimum. Moreover, providing the encryption unit (electronic processing circuit) 60 can enhance security.

### Third Embodiment

An IC card according to a third embodiment of the invention will now be described.

The IC card of the present embodiment is provided by adding a fingerprint detection unit 70 to which power is supplied from the power source 15 under the control of the CPU to the IC card 2 of the second embodiment. This unit serves as an identity authentication function device (electronic processing circuit). Here, like numerals indicate like elements of the IC cards 1 and 2, and like processes are omitted in a flowchart, which will be described later, and explanation thereof is simplified.

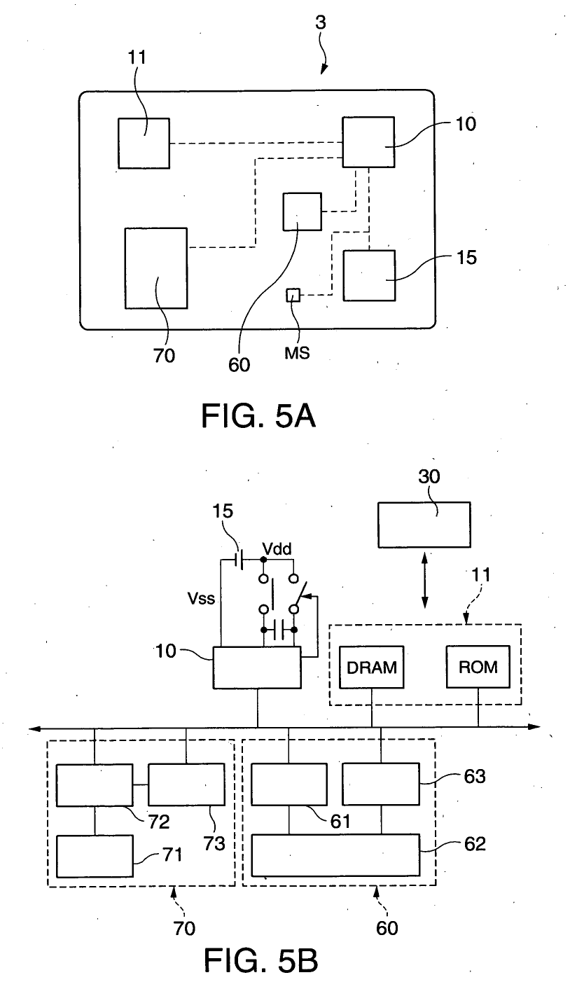

FIG. 5A is a plan view schematically showing the internal structure of the IC card of the present embodiment. Referring to the view, this IC card 3 includes a fingerprint detection unit 70 composed of an electronic processing circuit, which will be described in greater detail later, in addition to the elements of the IC card 2: the CPU 10, the power source 15, the IC unit 11, the micro switch MS and the encryption unit 60.

FIG. 5B is a block diagram showing the IC card 3 of the second embodiment.

Referring to this diagram, the IC card 3 includes the fingerprint detection unit 70 composed of another electronic processing circuit in addition to the IC card 2.

The fingerprint detection unit 70 includes a fingerprint sensor 71 for taking a user's fingerprint as individual information, a sensor controller 72 for the fingerprint sensor 71, and a RAM for the fingerprint sensor 71. The fingerprint sensor 71 takes a fingerprint to identify the user of the IC card 3, enabling the IC card 3 to be used with enhanced security.

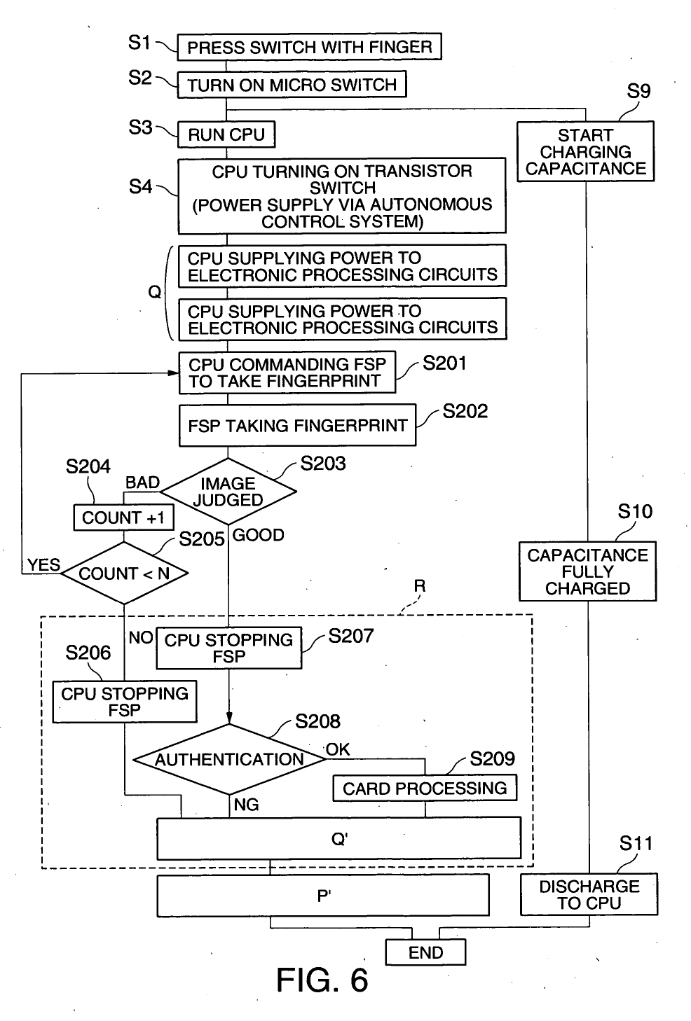

Referring now to the flowchart of FIG. 6, the use of the IC card 3 will be explained.

First, a user of the IC card 3 presses the micro switch MS with his or her finger to turn on this switch MS (Steps S1 and S2) in the same manner as in the first and second embodiments.

As a result, the power source 15 starts supplying power to the CPU 10 via the external control system circuit 20, and thereby the capacitance C starts to store electric charge (Step S9).

Receiving power from the power source 15, the CPU 10 starts running and issues a command to turn on the transistor switch TS included in the autonomous control system circuit 21. The CPU 10 then receives power from the power source 15 via the autonomous control system circuit 21 (Steps S3 and S4).

The CPU 10 turns on the transistor switch TS and then drives the encryption unit 60 through the above-described processing, enabling data communications between the external unit 30 and the IC card 3 (Process Q shown in FIG. 4).

Specifically, the CPU 10 provides power supply from the power source 15 to the encryption unit 60 (Step S101). The encryption unit 60 thus becomes a communicable status with the external device 30 under the control of the CPU 10 (Step S102).

Consequently, the CPU 10 commands the fingerprint detection unit (FPS) 70 to take a fingerprint (Step S201). Accordingly, the fingerprint detection unit 70 receives power from the power source 15 and becomes capable of taking a fingerprint. Here, if the user of the IC card 3 places his or her finger on the fingerprint sensor 71 included in the fingerprint detection unit 70, the fingerprint sensor 71 takes the user's finger print (Step S202).

If the user fails to place his or her finger on the fingerprint sensor 71 properly, fingerprint reading and authentication are unsuccessful.

Therefore, whether the fingerprint sensor 71 properly reads the taken image data is judged (Step S203)

If the fingerprint sensor 71 fails to read a fingerprint (BAD), the count of fingerprint reading increases by one (Count+1). Specifically, the count of fingerprint reading by the fingerprint sensor 71 is zero at first. When the fingerprint reading is judged “BAD” for the first time, the count increases to one (Step S204).

Here, the count of fingerprint reading is limited to N, and whether the count of fingerprint reading is less than N (Count<N) is judged.

If this is judged “YES”, which means that the count does not reach N, the process returns to Step S201 in which the CPU 10 commands the fingerprint detection unit 70 to take a fingerprint. The count of fingerprint reading up to this point is retained.

If this is judged “NO”, which means that the count reaches N, the CPU 10 stops power supply to the fingerprint detection unit 70 to stop this unit 70 (Step S206).

Stopping the fingerprint detection unit 70 (Step S206) is followed by Process Q′ of the second embodiment shown in FIG. 4. Specifically, the CPU 10 determines that processing of the IC card 3 is completed. Here, the completion of processing of the IC card 3 means that fingerprint reading is not successfully carried out within N times.

Accordingly, the CPU 10 stops power supply to the encryption unit 60, which is another electronic processing circuit included in the IC card 3.

After the CPU 10 stops power supply to the encryption unit 60, Process P′ of the first embodiment shown in FIG. 2 is carried out. Specifically, the CPU 10 issues a command to turn off the transistor switch TS. This command to turn the transistor switch off TS turns off the switch TS.

When the transistor switch TS is turned off, discharging the capacitance C to the CPU 10 drives the CPU 10. Therefore, the CPU 10 becomes a stop status by stopping power supply from this capacitance C.

The example that has been described is a case in which the fingerprint detection unit 70 fails to read a user's fingerprint.

Now, another case starting from Step S203 in which the fingerprint detection unit 70 properly reads a user's fingerprint will be described.

When the fingerprint sensor 71 successfully reads a fingerprint (GOOD), the CPU 10 stops power supply to the fingerprint detection unit 70 to stop this unit 70 (Step S207).

The CPU 10 then authenticates the fingerprint by checking whether the user's fingerprint data taken by the fingerprint detection unit 70 match the fingerprint data held in the IC unit 11 included in the IC card 3 (Step S208). This authentication of the fingerprint data (Step S208) prevents unauthorized use of the IC card 3 by third parties.

If the user of the IC card 3 is authorized as a result of this authentication (OK), the IC card 3 is enabled. When the IC card 3 is used as a credit card in the same manner as in the above-described embodiments, the IC card 3 communicates data encrypted by the encryption unit 60 with a credit card reader terminal (external device 30). Normal data communications between the IC card 3 and the reader terminal mean the completion of payment with this credit card (Step S209).

The completion of payment with the IC card 3 is followed by Processes Q′ and P′ as mentioned above. The CPU 10 determines that processing of the IC card 3 is completed and stops power supply to the encryption unit 60. The CPU 10 then turns off the transistor switch TS and becomes a stop status by stopping power supply from the capacitance C.

The IC card 3 according to the present embodiment can keep an increase in power consumed by the additional electronic processing circuits for the encryption unit 60 and the fingerprint detection unit 70, for example, to minimum. Moreover, providing the fingerprint detection unit 70 as well as the encryption unit 60 can enhance security and make the IC card more versatile.

It should be noted that the micro switch MS and the fingerprint detection unit 70 may be provided in a unit to the IC card 3. For example, the switch may be disposed on the back surface of the fingerprint sensor 71 included in the fingerprint detection unit 70. In this case, placing the finger on the fingerprint sensor 71 makes the CPU 10 start running, while releasing the finger from the fingerprint sensor 71 stops driving the CPU 10, and thereby the operability of the IC card 3 is further enhanced.

### Fourth Embodiment

An IC card according to a fourth embodiment of the invention will now be described.

The IC card of the present embodiment is provided by adding a display unit (electronic processing circuit) 50 to which power is supplied from the power source 15 under the control of the CPU to the IC card 3 of the third embodiment. Here, like numerals indicate like elements of the IC cards 1, 2 and 3, and like processes are omitted in a flowchart, which will be described later, and explanation thereof is simplified.

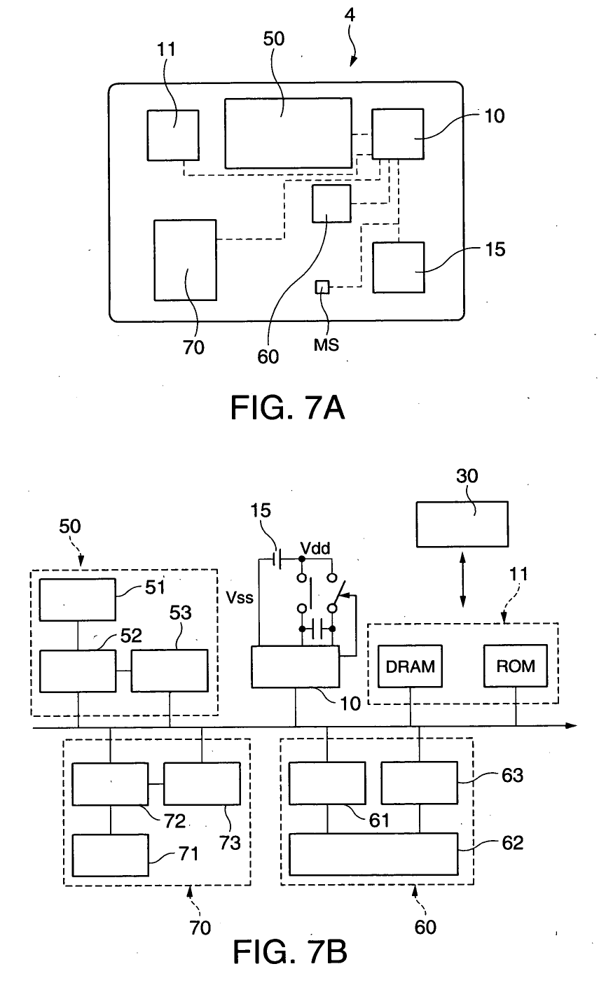

FIG. 7A is a plan view schematically showing the internal structure of the IC card of the present embodiment. Referring to the view, this IC card 4 includes the display unit 50 composed of an electronic processing circuit, which will be described in greater detail later, in addition to the elements of the IC card 3: the CPU 10, the power source 15, the IC unit 11, the micro switch MS, the encryption unit 60 and the fingerprint detection unit 70.

FIG. 7B is a block diagram showing the IC card 4 of the fourth embodiment.

Referring to this diagram, the IC card 4 includes the display unit 50 composed of another electronic processing circuit in addition to the IC card 3.

The display unit 50 includes a display 51, a display controller 52 and a VRAM 53. For example, an electrophoretic display device can be used here.

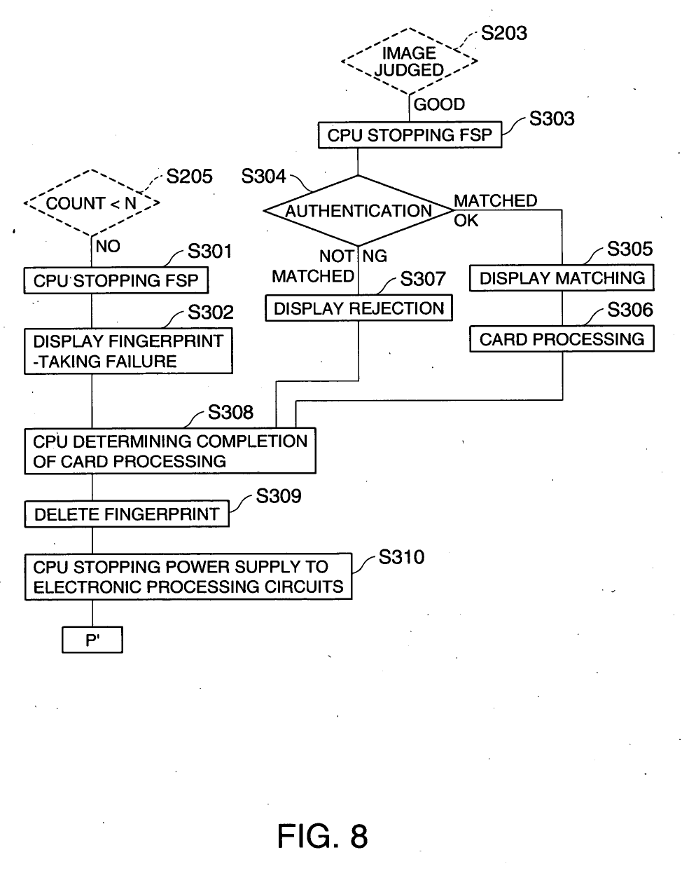

The IC card 4 according to the present embodiment handles almost the same processing as in the third embodiment until the judgment of whether the fingerprint sensor 71 included in the fingerprint detection unit 70 properly reads fingerprint data that have been taken. The processing of the present embodiment follows the flowchart of FIG. 8 instead of Process R shown in FIG. 6.

Note that the display unit 50 as well as the fingerprint detection unit 70 is driven under the control of the CPU 10 as described in the third embodiment.

If reading of the fingerprint that has been taken is judged “NO”, which means that the count of fingerprint reading reaches N in Step S205 shown in FIG. 6, the CPU 10 stops power supply to the fingerprint detection unit 70 to stop this unit 70 (Step S301).

After stopping the fingerprint detection unit 70, the CPU 10 shows that the fingerprint reading has been failed on the display unit 50 (Step S302). The CPU 10 then determines that processing of the IC card 4 is completed (Step S308).

When the fingerprint sensor 71 successfully reads a fingerprint (GOOD), the CPU 10 stops power supply to the fingerprint detection unit 70 to stop driving this unit 70 (Step S303).

The CPU 10 then authenticates the fingerprint by checking whether the user's fingerprint data taken by the fingerprint detection unit 70 match the fingerprint data held in the IC unit 11 included in the IC card 3 (Step S304).

If the fingerprint is identified as a result of this authentication (OK), which means that the user of the IC card 4 is authorized, the display unit 50 displays “OK”, for example, showing that the fingerprint has been authorized (Step S305).

The user can easily see that the fingerprint detection processing is completed as the display unit 50 shows the authorization result (OK). Third parties (e.g. a shop clerk who was passed the credit card) can also see that the authorized user is using the IC card 4.

As the fingerprint is authorized, the IC card 4 is enabled. When the IC card 4 is used as a credit card in the same manner as in the above-mentioned embodiments, the IC card 4 communicates data encrypted by the encryption unit 60 with a credit card reader terminal (external device 30). Normal data communications between the IC card 4 and the reader terminal complete mean the completion of payment with this credit card (Step S306).

The CPU 10 then determines that processing of the IC card 4 is completed (Step S308).

If the fingerprint is not identified as a result of the authentication in Step S304 (NG), which means that the user of the IC card 4 is a third party and not authorized, the display unit 50 displays “NG”, for example, showing that the fingerprint has not been authorized and the user is rejected (Step S307).

Third parties can easily see the unauthorized use of the IC card 4, for example, on the display unit 50 showing the “NG” authorization result. It is thus possible to enhance security against the unauthorized use of the IC card 4.

As the display unit 50 shows the rejection, the CPU 10 determines that processing of the IC card 4 is completed (Step S308).

Note that the CPU 10 determines that processing of the IC card 4 is completed after the processing of the fingerprint detection unit 70 irrespective of authorization results.

After the CPU 10 determines that processing of the IC card 4 is completed in Step S308, the image (e.g. “OK” or “NG”) on the display unit 50 is deleted (Step S309).

Power supply to the other electronic processing circuits, i.e. the encryption unit 60 and the fingerprint detection unit 70, are stopped thereafter (Step S310).

Finally, Process P′ shown in the flowchart of FIG. 6 and described in FIG. 2 in greater detail is carried out in which the CPU 10 issues a command to turn off the transistor switch TS as the IC card 3 of the third embodiment does. The transistor switch TS is turned off by this command to turn off this switch TS.

As the transistor switch TS is turned off, the CPU 10 driven by the capacitance C becomes a stop status.

The IC card 4 according to the present embodiment can keep an increase in power consumed by the additional electronic processing circuits for the fingerprint detection unit 70, the display unit 50 and the encryption unit 60, for example, to minimum. Also, displaying results of the fingerprint authorization on the display unit 50 can make the user easily see the results.

If a person other than the authorized user of the IC card 4 tries to use the card, another person who was passed the card can easily see the unauthorized use on the display unit 50. This processing enhances security and makes the IC card 4 more versatile.

While the IC card of the present embodiment is not in use, both the micro switch MS and the transistor switch TS are off and do not supply power to the CPU 10 as in the above-mentioned embodiments. Furthermore, the electronic processing circuits for processing this IC card are provided. The CPU 10 controls power supply to these electronic processing circuits. Therefore, no power is supplied to the CPU 10 and the electronic processing circuits while the card is not in use, which saves power consumption. The micro switch MS stays on and provides power supply to the CPU 10 while this switch MS is pressed. Once the micro switch MS is turned on and starts providing power supply to the CPU 10, the CPU 10 commands the autonomous control system circuit 21 to turn on the transistor switch TS.

The transistor switch TS included in the autonomous control system circuit 21 stays on at least during the period the CPU 10 commands so, and provides power supply to the CPU 10 during this period. Accordingly, the CPU 10 secures power supply to itself by keeping the transistor switch TS included in the autonomous control system circuit 21 on while the micro switch MS stays on. In other words, even if the micro switch MS is on to supply power to the CPU 10 and turned off thereafter, the CPU 10 controls on and off of the transistor switch TS on its own. Accordingly, the CPU 10 does not lack power by turning off the micro switch MS included in the external control system circuit 20, and controls power supply for itself with the autonomous control system circuit 21. After determining that the IC card completes predetermined processing and shutting off the power source, the CPU 10 commands the autonomous control system circuit 21 to turn off the transistor switch TS.

The capacitance C, provided in parallel with the CPU 10, stores electric charge while the power source 15 supplies power to the CPU 10 via the external control system circuit 20 or the autonomous control system circuit 21. As the CPU 10 commands the autonomous control system circuit 21 to shut off power supply and thereby the transistor switch TS shifts to an off status, the electric charge stored in the capacitance C is supplied to the CPU 10, securing the normal operation of the CPU 10. Even when power supply from the power source 15 becomes less as the transistor switch TS is turned off, the CPU 10 can complete the command of completely turning off the transistor switch TS with power supplied by the capacitance C. The capacitance C therefore stores enough power for the CPU 10 to keep commanding the autonomous control system circuit 21 to shut off power supply even after the transistor switch TS is completely turned off. As the CPU 10 uses up the electric charge stored in the capacitance C, the CPU 10 becomes a stop status with no power supplied. The CPU 10 stays completely off until the micro switch MS is turned on to make the external control system circuit 20 restart providing power supply.

Accordingly, when the micro switch MS is not turned on and the IC card is not in use, the CPU 10 receives no power, which saves power consumption due to standby power of the IC card, for example. It is thus possible to efficiently use the power source of the IC card. Furthermore, since the IC card stops power supply to the CPU 10 on its own, it is possible to prevent unnecessary power consumption because the user of this card forgets to turn off the power source 15.

After determining that the IC card completes predetermined processing, the CPU 10 shuts off power supply to the electronic processing circuits included in the IC card to stop the circuits and then commands the autonomous control system circuit 21 to turn off the transistor switch TS. The CPU 10 stops power supply to the electronic processing circuits after they complete their roles, so that they can complete their functions safely, thereby minimizing the risk of damaging the CPU 10.

It should be noted that the above-described embodiments do not limit the invention, and various changes can be made.

For example, while each of the IC cards is used for data communications with a credit card reader terminal in the above-described embodiments, they can be used for other purposes, such as bank cash cards. Also, the invention can be applied to more advanced IC cards equipped with other electronic processing circuits than the fingerprint detection unit 70, the display unit 50 and the encryption unit 60.

Furthermore, examples of portable information devices may include not only the IC cards but also mobile phones and PDAs that are driven by a battery and are turned off to reduce power consumption while they are not in use.

The entire disclosure of Japanese Patent Application No. 2005-045254, filed Feb. 22, 2005 is expressly incorporated by reference herein.

1. A portable information device having a central processing unit and a power source coupled to the central processing unit and driving the central processing unit, comprising:
an external control system circuit provided between the power source and the central processing unit, and providing power supply from the power source to the central processing unit by an external input; and
an autonomous control system circuit providing power supply from the power source to the central processing unit under control of the central processing unit;
the external control system circuit and the autonomous control system circuit being coupled in parallel with each other,
the external control system circuit including a mechanical switch turned on and off by an external input, and
the autonomous control system circuit including a transistor switch turned on and off under control of the central processing unit.

2. The portable information device according to claim 1, wherein both the mechanical switch and the transistor switch are off if the portable information device is not in use.

3. The portable information device according to claim 1, wherein the mechanical switch is on and provides power supply to the central processing unit only during a period in which the mechanical switch is pressed.

4. The portable information device according to claim 3, wherein the central processing unit turns on the transistor switch if the mechanical switch is turned on and starts providing power supply to the central processing unit.

5. The portable information device according to claim 4, wherein the transistor switch is on and provides power supply to the central processing unit during a period in which the central processing unit issues a command to turn on the switch.

6. The portable information device according to claim 5, wherein the central processing unit controls on and off of the transistor switch if the mechanical switch is turned on to provide power supply to the central processing unit and turned off thereafter.

7. The portable information device according to claim 6, wherein the central processing unit determines that the portable information device completes predetermined processing and issues a command to turn off the transistor switch thereafter.

8. The portable information device according to claim 1, further comprising:
a capacitance provided between a positive power source and a negative power source of the autonomous control system circuit and in parallel with the central processing unit;
the capacitance storing electric charge during a period in which the power source supplies power to the central processing unit.

9. The portable information device according to claim 1, further comprising:
an electronic processing circuit to which power is supplied under control of the central processing unit;
the electronic processing circuit processing the portable information device.

10. The portable information device according to claim 9, wherein the central processing unit determines that the portable information device completes predetermined processing, stops the electronic processing circuit, and issues a command to turn off the transistor switch in this order.

11. The portable information device according to claim 9, further comprising:
an identity authentication function device to which power is supplied under control of the central processing unit;
the identity authentication function device taking identity authentication information by a command from the central processing unit.
